(19) United States
(12) Patent Application Publication
(10) Pub. No.: US 2025/0371864 A1
(43) Pub. Date: Dec. 4, 2025

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventors: KENJI ISATAKE, Kanagawa (JP); MASAKAZU FUJIKI, Kanagawa (JP)

(21) Appl. No.: 19/212,977

(22) Filed: May 20, 2025

(30) Foreign Application Priority Data
May 29, 2024 (JP) 2024-087184

(51) Int. Cl. G06V 10/96; G06V 10/40

(52) U.S. Cl. CPC G06V 10/96; G06V 10/40; G06V 2201/06; G06V 2201/07

(57) ABSTRACT

An information processing apparatus includes at least one processor that executes instructions to acquire measurement information obtained by measuring a target of a task and a periphery of target, or recognition information recognized based on the measurement information, acquire a content of the task as task information, determine a control method for executing the task based on confidential information contained in the measurement information or the recognition information, and the task information, and execute the control method based on the measurement information or the recognition information.

### BACKGROUND

### Technical Field

The present disclosure relates to an information processing apparatus, an information processing method, and a storage medium.

### Description of Related Art

Autonomous vehicles (movable units or bodies) that operate in environments of factories, logistics warehouses or the like, such as unmanned transport cars (e.g., automated guided vehicles (AGVs)) and autonomous movable units (e.g., autonomous transport robots (AMRs)), have conventionally been known.

Japanese Patent Application Laid-Open No. 2019-62308 discloses a technology for protecting privacy and confidentiality through masking processing to sensed data and for preventing application hindrance for a robot due to the masking processing. More specifically, this prior art reference discloses a technology for adaptively switching among image processing, changing a camera direction, and changing a route of the movable unit according to a positional relationship between one of the applications of stopping, talking, and moving and an imaging prohibited area.

This technology disclosed in Japanese Patent Application Laid-Open No. 2019-62308 may not be able to reconcile confidentiality maintenance and task execution depending on the task content of the robot.

### SUMMARY

An information processing apparatus according to one aspect of the disclosure includes at least one processor that executes instructions to acquire measurement information obtained by measuring a target of a task and a periphery of target, or recognition information recognized based on the measurement information, acquire a content of the task as task information, determine a control method for executing the task based on confidential information contained in the measurement information or the recognition information, and the task information, and execute the control method based on the measurement information or the recognition information. An information processing method corresponding to above information processing apparatus also constitutes another aspect of the disclosure. A storage medium storing a program that causes a computer to execute the above information processing method also constitutes another aspect of the disclosure.

An information processing apparatus according to another aspect of the disclosure includes at least one processor that executes instructions to acquire measurement information obtained by measuring a target of a task and a periphery of target, or recognition information recognized based on the measurement information, acquire a content of the task as task information, determine a processing method for processing the measurement information or the recognition information based on the task information, and control a task execution apparatus based on the measurement information or the recognition information processed by the processing method. An information processing method corresponding to above information processing apparatus also constitutes another aspect of the disclosure. A storage medium storing a program that causes a computer to execute the above information processing method also constitutes another aspect of the disclosure.

Further features of various embodiments of the disclosure will become apparent from the following description of embodiments with reference to the attached drawings.

### BRIEF DESCRIPTION OF THE DRAWINGS

FIG. 1 is a schematic diagram illustrating an example of an application scene of an information processing apparatus according to each example.

FIG. 2 is a block diagram illustrating a module configuration of a system according to each example.

FIG. 3 is a block diagram illustrating a hardware configuration of the information processing apparatus according to each example.

FIG. 4 is a flowchart illustrating the processing performed by the information processing apparatus according to each example.

FIG. 5 is a correspondence table among task information, confidential information (classified information), and control-method types in Example 1.

FIG. 6 is a correspondence table among task information, confidential information, and control-method types in Example 2.

FIG. 7 illustrates a display screen as an example of a notifying unit in Example 4.

### DETAILED DESCRIPTION

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a detailed description will be given of examples according to the present disclosure. The following examples do not limit the disclosure according to the claims, and all of the combinations of features described in the examples are not necessarily essential to the disclosed solution.

### Example 1

A description will now be given of an overview of the environment in which the information processing apparatus according to Example 1 of the present disclosure is utilized. This example will discuss an example in which the information processing apparatus is applied in a situation in which a task (operation or work) execution apparatus that collaborates with a vision system executes a predetermined task for an object (target of the task) whose appearance includes confidential information (classified information).

The vision system is an apparatus that recognizes and measures surrounding objects and measures its own position and orientation based on information acquired from a sensor. The vision system determines the task content to be executed by the task execution apparatus and issues task instructions. The task execution apparatus is, for example, a robot that executes a predetermined task. In this example, the task execution apparatus executes a task based on information output by the vision system.

The information measured by the sensor includes confidential information. Accordingly, the information processing apparatus of the vision system processes the information such that it does not include confidential information according to the content (type) of the task and limits the information measured by the sensor so that the task can be executed. Thereby, both confidentiality maintenance and task execution can be achieved.

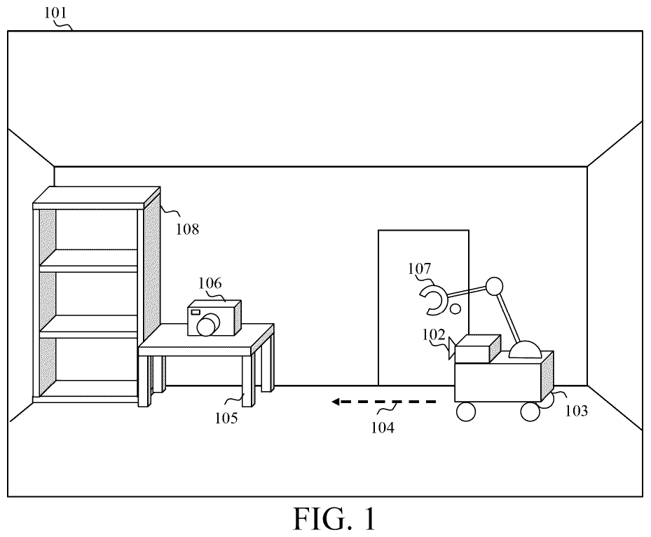

Referring now to FIG. 1, a description will be given of an illustrative application scene of the information processing apparatus according to this example. FIG. 1 is a schematic diagram illustrating the illustrative application scene of the information processing apparatus according to the present example. FIG. 1 illustrates a state (task environment 101) in which a task execution apparatus 103 equipped with a vision system 102 according to this example performs a pick-and-place task (a predetermined task) while traveling along a route 104. A specific pick-and-place task is a task in which a prototype 106 of a camera on a desk 105 is grasped with a finger hand 107 and the prototype 106 is placed on a neighboring shelf 108.

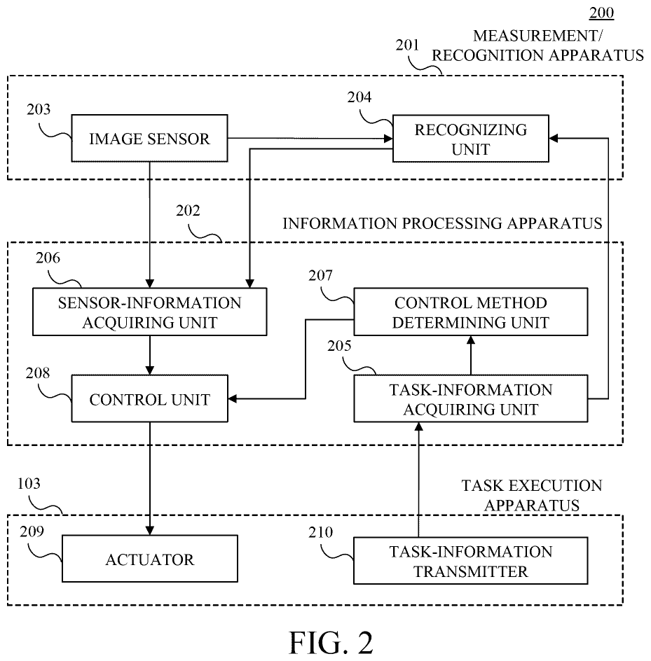

Referring now to FIG. 2, a description will be given of the module configuration of the vision system 200 according to this example. FIG. 2 is a block diagram illustrating the module configuration of the vision system 200 according to this example. The vision system 200 includes a measurement/recognition apparatus 201, an information processing apparatus 202, and the task execution apparatus 103.

The measurement/recognition apparatus 201 includes an image sensor 203 and a recognizing unit 204. The task execution apparatus 103 includes a task-information transmitter 210 and an actuator 209 that is used to execute the task. The information processing apparatus 202 includes a task-information acquiring unit (second acquiring unit) 205, a sensor-information acquiring unit (first acquiring unit) 206, a control method determining unit 207, and a control unit 208. The information processing apparatus 202 can communicate with each of the task execution apparatus 103 and the measurement/recognition apparatus 201. In this example, the measurement/recognition apparatus 201 and the information processing apparatus 202 are included in the vision system 102.

The task-information acquiring unit 205 acquires the task content and confidential information content as task information. The recognizing unit 204 acquires information recognizing a specific target based on information acquired from the image sensor 203 and the task-information acquiring unit 205. The recognized information includes, but is not limited to, information regarding the position and orientation of the vision system 102 and the task execution apparatus 103, or other information that changes according to the task content.

The sensor-information acquiring unit 206 acquires information on the task target and its surroundings from the image sensor 203 or the recognizing unit 204. The control method determining unit 207 determines a control method for performing the task while protecting confidential information, based on the task information acquired by the task-information acquiring unit 205. The detailed method for determining the control method will be described later. The control unit 208 executes the control method determined by the control method determining unit 207, based on the information acquired by the sensor-information acquiring unit 206.

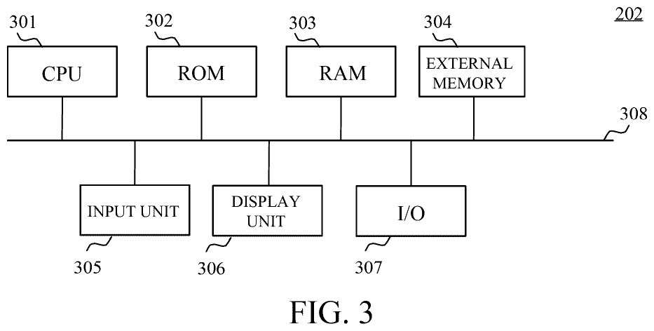

Referring now to FIG. 3, the hardware configuration of the information processing apparatus 202 according to this example will be described. FIG. 3 is a block diagram illustrating the hardware configuration of the information processing apparatus 202 according to this example. That is, the information processing apparatus 202 in FIG. 2 has a hardware configuration illustrated in FIG. 3.

A CPU 301 controls various devices connected to the bus 308, and executes the information processing according to this example. A read only memory (ROM) 302 stores a Basic Input/Output System (BIOS) program and boot program. A random access memory (RAM) 303 is used as the main memory for CPU 301. An external memory 304 stores the programs to be processed by information processing apparatus 202.

An input unit 305 is a keyboard and mouse, and performs processing related to the input of information. A display unit 306 outputs the calculation results by the information processing apparatus 202 to a display apparatus (notifying unit) according to instructions from the CPU 301. The display unit can be of any type, such as a liquid crystal display apparatus, a projector, or a light emitting diode (LED) indicator. The bus 308 connects the CPU 301, RAM 303, ROM 302, and the external memory 304 so that they can communicate with each other. The image sensor 203, the recognizing unit 204, the actuator 209, and the task-information transmitter 210 are connected to the input/output (I/O) 307.

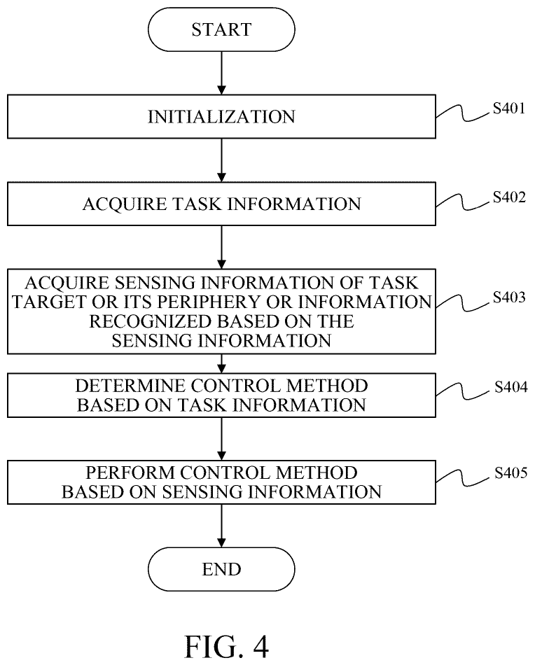

Referring now to FIG. 4, a description will be given of the processing (information processing method) executed by the information processing apparatus 202 according to this example. FIG. 4 is a flowchart illustrating the processing executed by the information processing apparatus 202. The processing of the flowchart in FIG. 4 starts simultaneously with the start of travel of the task execution apparatus 103 in the task environment 101.

First, in step S401, the control unit 208 initializes the information managed by the information processing apparatus 202. During the initialization, for example, the control unit 208 loads data of a correspondence table among task information, confidential information, and a control method, which will be described later, from the external memory 304. Next, in step S402, the task-information acquiring unit 205 acquires information on the content of the task (task information) and the target of confidentiality maintenance as task information. The acquired information changes according to the task information.

Next, in step S403, the sensor-information acquiring unit 206 acquires sensing information (measurement information) obtained by measuring the task target and its periphery, or information recognized based on the sensing information (recognition information). The acquired detailed sensing information or recognition information changes according to the task information. The sensing information includes, for example, information on the captured image that is used to perform the task or the three-dimensional shape of the surrounding environment, but is not limited to them. The recognition information includes, for example, information on the position and orientation, shape, and color information on the task target or surrounding obstacles, or the position and orientation of the vision system 102, but is not limited to them.

Next, in step S404, the control method determining unit 207 determines a control method for performing the task while protecting the confidential information, based on the task information acquired by the task-information acquiring unit 205, according to the task information. The method for determining the control method according to the task information will be described later. Next, in step S405, the control unit 208 executes the control method determined by the control method determining unit 207 based on the information acquired by the sensor-information acquiring unit 206.

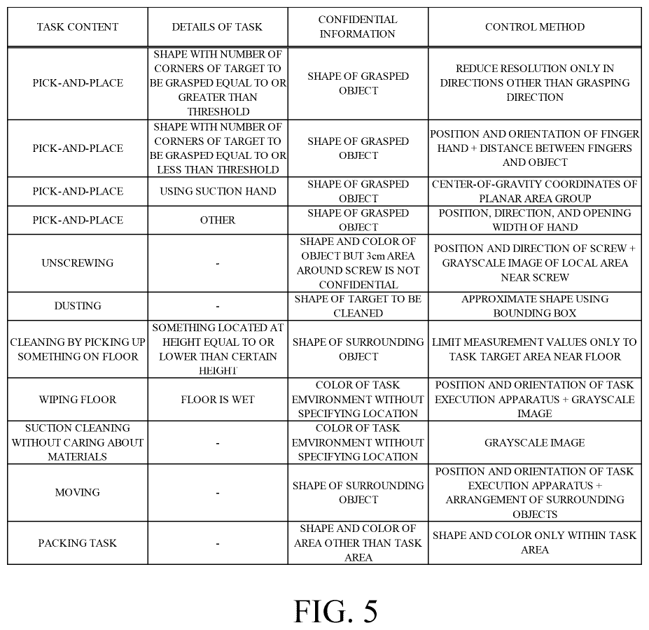

Referring now to FIG. 5, a detailed description will be given of a method of determining the control method. FIG. 5 is a correspondence table among task information, confidential information, and a control method, and is used in the processing of step S404 in FIG. 4. The table in FIG. 5 includes “task content,” “details of task,” “confidential information,” and “control method,” and indicates that the “control method” is determined according to the contents of the “task content,” “task details,” and “confidential information.” The “task content” indicates the task content (pick-and-place, unscrewing, dusting, etc.) performed by the task execution apparatus 103. The “task details” indicate supplementary information for the task content. The “confidential information” is information that is subject to confidentiality. The “control method” indicates a method of processing information provided to the task execution apparatus 103 so as not to contain confidential information while ensuring the execution of the task. The “control method” is broadly classified into control types including at least one of “reducing the resolution” of the output information, “reducing the dimension,” “limiting a range of a measurement value” (limiting a measurement range (spatial range)), or “replacing it with abstract information.” However, the processing method is not limited to them, and another method may be used as long as it can avoid the inclusion of specific confidential information.

In step S404 of FIG. 4, first, a “control method” is determined from the correspondence table based on the “task content” and “confidential information” acquired by the task-information acquiring unit 205. Then, the control method determining unit 207 determines specific control content as necessary according to the control type linked to the determined “control method.” For example, in a case where the control type is “reducing the resolution,” the method of reducing the resolution is determined. In a case where the control type is “reducing the dimension,” the method of reducing the dimension is determined. In a case where the control type is “limiting a range of the measurement value,” the control unit 208 determines what information to limit to what range. In a case where the control type is “replacing with abstract information,” the control unit 208 determines what information to abstract and how.

The specific contents determined by the flow according to this example are as follows.

In a case where the task content is “pick-and-place,” the task details are a “shape with number of corners of a target to be grasped equal to or greater than a threshold value,” and the confidential information is a “shape of a grasped object,” a control method for reducing the resolution is determined as “maintaining a shape in a grasping direction, and reducing the resolution of the shape in other directions.” In a case where the number of corners of the target is equal to or greater than the threshold value, a resolution value is determined and set that does not allow detection of the positions and angles of edges and faces, which are shape information, in directions other than the grasping direction. This is because, in order to stably grasp the target with the arm, it is necessary to accurately recognize the contact point of the arm that does not wobble when the arm grasps the target. On the other hand, even if the resolution of the shape is reduced in directions other than the grasping direction, as long as the resolution of the shape in the grasping direction is high, the grasping task can be performed, so the above control method is determined.

In a case where the task content is “pick-and-place,” the task details are a “shape with number of corners of a target equal to or less than a threshold value,” and the confidential information is a “shape of a grasped object,” a control method for reducing dimensions is determined as “providing a position and orientation of the finger hand and a distance between the fingers and the object.” This allows the task to be executed without disclosing the shape in a case where the number of corners of the target is equal to or less than the threshold value.

In a case where the task content is “pick-and-place,” the task details are “using a suction hand,” and the confidential information is a “shape of a grasped object,” a control method for reducing dimensions is determined as “providing center-of-gravity coordinates of a planar area group.” This planar area is larger than the suction cup of the suction hand. In a case where the center-of-gravity coordinates of this planar area are known, the target can be grasped without disclosing its shape, so the above control method can be determined.

In a case where the task content is “pick-and-place,” the task details are not one of the above three patterns, and the confidential information is a “shape of a grasped object,” a control method for replacing with abstract information is determined as “providing a hand position, hand direction, and hand opening width.” This is because grasping is possible without shape information if the hand position, orientation, and opening width at the time of grasping are known, and thus the above control method can be determined.

In a case where the task content is “unscrewing” and the confidential information is a “shape and color of an object (while the shape is not confidential in a 3-cm area around a screw,” a control method that is a combination of a method of reducing dimensions and replacing with abstract information is determined as “providing information on a position and orientation of a screw, and a grayscale image of a local area near the screw.” This means that if the arm can move to a position near the position of the screw, and an image of only the area around the screw is delivered, the shape of the object will not be necessary for the task. The above control method can be determined because feedback control of the movement of the arm to the position of the screw (without error) for unscrewing is possible by converting it into a grayscale image, even without color information.

In a case where the task content is “dusting” and the confidential information is a “shape of a target to be cleaned,” a control method for reducing the resolution is determined as “approximating a three-dimensional (3D) shape of a target to be cleaned using a bounding box.” Dusting can be performed even if a distance to the target to be cleaned is rough, and thus the above control method can be determined.

In a case where the task content is “picking up something on a floor,” the task details are “something located at a height equal to or lower than a certain height,” and the confidential information is a “shape of a surrounding object,” a control method for limiting a range of measurement values is determined as “limiting measurement values to only a task target area near a floor.” The local area covers measurement values corresponding to the height equal to or lower than a certain height from the floor, and any measurement values corresponding to the height above that height are excluded and provided. The above control method can be determined because only information about the area near the floor is required for the task of picking up something on the floor.

In a case where the task content is “wiping a floor,” the task details are “a floor is wet,” and the confidential information is a “color of a task environment without specifying a location,” a control method is determined as “providing a position and orientation of a task execution apparatus and a grayscale image.” This corresponds to a combination of a method of reducing dimensions and a method of replacing them with abstract information. The above control method can be determined because the degree of wetness can be determined using a grayscale image even without color information.

In a case where the task content is “suction cleaning without caring about materials” and the confidential information is a “color of a task environment without specifying a location,” a control method for reducing dimensions is determined as “providing a grayscale image.” In the case of suction cleaning without identifying tatami mats or carpets, the cleaning environment can be recognized without color information on the floor, so the above control method can be determined.

In a case where the task content is “moving” and the confidential information is a “shape of a surrounding object,” a control method for replacing with abstract information is determined as “providing information on the position and orientation of the task execution apparatus and information on the arrangement of the surrounding object.” As long as the current position of the task execution apparatus and the positions of surrounding obstacles are known, movement is possible even without the shapes of surrounding obstacles, so the above control method can be determined.

In a case where the task content is a “packing task” and the confidential information is a “shape and color of an area other than a task area,” a control method for limiting a range of the measurement values is determined as “providing information on a shape and color only within the task area.” The above control method can be determined because as long as the shape and color within the task area are known, no information outside the task area is required.

This example can maintain confidentiality and execute the task.

### Variation 1

A description will now be given of Variation 1 according to this example. In the above example, the vision system 102 is mounted on the task execution apparatus 103, and is an apparatus that estimates its own position, determines the task content to be performed by the task execution apparatus 103, and issues task instructions. Self-position estimation can be performed, for example, using Visual Simultaneous Localization and Mapping (SLAM).

This example is not limited to this implementation, and other forms may be used as long as the position and orientation of the task execution apparatus 103 can be measured, the task content to be performed by the task execution apparatus 103 can be determined, and task instructions can be given. For example, it may be an autonomously moving movable unit physically different from the task execution apparatus 103, or a network camera fixed to the task execution location. That is, at least a part of the functions of the vision system 102 may be provided to an apparatus away from the task execution apparatus 103, and information may be exchanged by wireless communication or the like. For example, it may be configured to execute at least a part of the functions of the information processing apparatus 202 by an external device such as cloud computing.

Thereby, a control method that protects confidentiality can be achieved regardless of the form of the vision system 102.

### Variation 2

A description will now be given of Variation 2 according to this example. The above example determines the control method using confidential information, but is not limited to this implementation. Even if there is no area designation of specific confidential information, in a case where there is confidential information to be dealt with, a control method may be determined without identifying the confidential information. For example, the control method may be determined in a known state in which the color of the surrounding environment is omitted.

The above example acquires confidential information on the task content from the task-information acquiring unit 205, but this is not limited to this implementation. As long as the confidential information to be dealt with can be obtained, confidential information may be obtained from a means other than the task-information acquiring unit 205. For example, the information processing apparatus 202 may further include a confidentiality specifying information acquiring unit for acquiring specific confidential information, and may acquire the confidential information to be dealt with from the confidentiality specifying information acquiring unit.

Thereby, both confidentiality maintenance and task execution can be achieved, regardless of the form of the method for acquiring the confidential information.

### Example 2

A description will now be given of Example 2 according to the present disclosure. Example 1 has discussed a control method for processing information to be output to the task execution apparatus 103. On the other hand, this example will discuss a method for adjusting (determining) the operation of the task execution apparatus 103 depending on the processing of information. More specifically, the operation timing is advanced or the operation speed is slowed down. This adjustment allows the work to be performed more safely.

The usage of the information processing apparatus 202 according to this example is the same as that in FIG. 1, and thus a description thereof will be omitted. The configuration of the system in this example is similar to that in FIG. 2, and thus a description thereof will be omitted. The hardware configuration of the information processing apparatus 202 in this example is similar to that in FIG. 3, and thus a description thereof will be omitted.

Referring now to FIGS. 4 to 6, a description will be given of the processing of the information processing apparatus 202 according to this example. As described above, this example processes the output information to the task execution apparatus 103, and further determines a method of controlling the task execution apparatus 103 in accordance with a change in information due to the processing of the output information. The method of determining the control method for processing information is similar to that in Example 1, and thus a description thereof will be omitted.

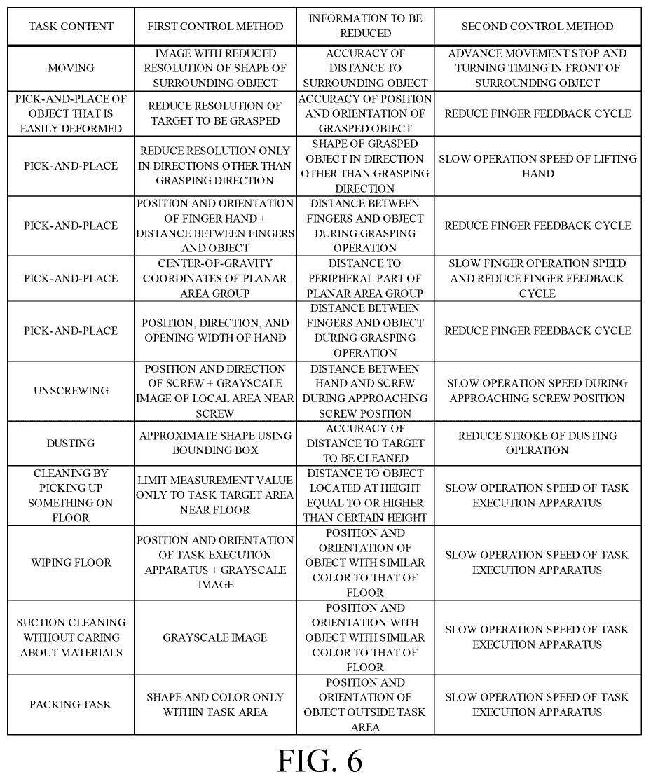

FIG. 6 explains the method of determining the control method for the task execution apparatus 103, and is a table that is used in the processing of determining a second control method, which is performed in step S404 in FIG. 4. The table in FIG. 6 includes “task content,” “first control method,” “information to be reduced,” and “second control method,” and illustrates that the “information to be reduced” is determined in association with the “first control method,” and the “second control method” is determined according to the “information to be reduced” and the “task content.” The “second control method” is a control method for the task execution apparatus for executing the task content while compensating for the “information to be reduced” caused by the “first control method.”

In the processing of determining the second control method, first, the “information to be reduced” is determined from the correspondence table based on the “first control method.” Next, the “second control method” is determined from the correspondence table based on the “task content” and the “information to be reduced.” The specific contents determined by the above flow are as follows.

In a case where the task content is “moving” and the first control method is a control method for “providing an image with reduced resolution of a shape of a surrounding object,” the information to be reduced is determined as the “accuracy of a distance to a surrounding object.” This is because the accuracy of detecting the distance to the surrounding object based on the image decreases due to the image with reduced resolution.

In a case where the task content is “moving” and the information to be reduced is the “accuracy of a distance to a surrounding object,” a second control method is determined as “advancing movement stop and turning timing in front of a surrounding object.” The timing to be determined is set to a reciprocal of the reduced resolution. This is because the accuracy of the distance to the object becomes unclear due to the reduced resolution, and in order to prevent collisions with the surrounding object, the movement stop and turning timing are advanced according to the reduced resolution. Thus, the control method of the task execution apparatus is determined.

In a case where the task content is “pick-and-place of an object that is easily deformed” and the first control method is a control method for “providing an image with a reduced resolution of a target,” it is determined that the information to be reduced is a “position and orientation of a target.” This is because the accuracy of detecting the position and orientation of the target decreases in an image with a reduced resolution. In a case where the task content is “pick-and-place an object that is easily deformed” and the information to be reduced is a “position and orientation of the target,” the second control method is determined as “reducing a finger feedback cycle.” The feedback cycle is set to a value that advances the cycle by the ratio of the reduced resolution. The control method of the task execution apparatus is determined so as to prevent the fingers from failing to grasp the object or grasping it with strong force causing the target to deform due to the low accuracy of a distance between the target and fingers and consequently a coarse grasping position.

In a case where the task content is “pick-and-place” and the first control method is a control method of “reducing the resolution only in directions other than the gripping direction,” the information to be reduced is determined as a “shape of a target in directions other than a gripping direction.” In a case where the task content is “pick-and-place” and the information to be reduced is a “shape of a target in directions other than a gripping direction,” the second control method is determined as “slowing the operation speed of lifting a hand.” The determined operation speed is set to a speed at which the arm can immediately stop moving. The control method of the task execution apparatus is determined so as to prevent collisions during lifting due to coarse shape information on the target in directions other than the gripping direction.

In a case where the task content is “pick-and-place” and the first control method is a control method of “providing a position and orientation of a finger hand and a distance between fingers and an object,” the information to be reduced is determined as a “distance between fingers and an object during a gripping operation.” In a case where the task content is “pick-and-place” and the information to be reduced is a “distance between fingers and an object during a gripping operation,” the second control method is determined as “reducing a finger feedback cycle.” The task execution apparatus executes the task during the gripping operation based on the distance between the fingers and the object, but when the position and orientation of the finger changes due to the gripping operation, the distance between the changed finger position and the object is required. Therefore, by reducing the feedback cycle, the distance between the fingers and the object can always be recognized while the gripping task can be executed.

In a case where the operation is “pick-and-place” and the first control method is a control method of “providing center-of-gravity coordinates of a planar area,” the information to be reduced is determined as “a distance to a peripheral part of a planar area group.”

In a case where the operation is “pick-and-place” and the information to be reduced is a “distance to a peripheral part of a planar area group,” the second control method is determined to be “reducing a feedback period while slowing a finger operation speed.” This is because if only the position of the planar area is provided to the task execution apparatus in the first control method, information about the peripheral part of the planar area is not delivered. Therefore, in order to prevent the hand from colliding with surrounding objects in the planar area during the gripping operation, the control method for the task execution apparatus is determined.

In a case where the task content is “pick-and-place” and the first control method is a control method for “providing a hand position, hand direction, and hand opening width,” the information to be reduced is determined as “a distance between the fingers and the object during the gripping operation.”

In a case where the task content is “pick-and-place” and the information to be reduced is “a distance between fingers and an object during a gripping operation,” a second control method is determined as “reducing a finger feedback cycle.” The task execution apparatus 103 performs operations based on the finger opening degree during the gripping operation. In a case where the finger opening degree changes due to the gripping operation, the next finger opening degree is required. Therefore, by reducing the feedback cycle, the gripping task can be performed while the finger opening degree over time can be always recognized.

In a case where the task content is “unscrewing” and the first control method is a control method of “providing information on a position and orientation of a screw and a grayscale image of a local area near the screw,” the information to be reduced is determined as “a distance between a hand and a screw during approaching the screw position.” In a case where the task content is “unscrewing” and the information to be reduced is a “distance between a hand and a screw during approaching the screw position,” the second control method is determined as “slowing an operation speed during approaching the screw position.” This is because there is no information on the distance between the hand and the screw while the arm is moving to the vicinity of the screw position or during feedback control based on the grayscale image, so the control method for the task execution apparatus 103 is determined to perform the gripping task safely without the screw and the hand accidentally colliding.

In a case where the task content is “dusting” and the first control method is a control method of “approximating a three-dimensional shape of a target with a bounding box,” the information to be reduced is determined as the “accuracy of a distance to a target to be cleaned.” In a case where the task content is “dusting” and the information to be reduced is the “accuracy of a distance to a target to be cleaned,” the second control method is determined as “reducing a stroke of a dusting operation.” In a case where the accuracy of the distance to the cleaning target decreases by approximating the three-dimensional shape of the target with the bounding box, the control method of the task execution apparatus is determined to clean more safely without colliding with the target during the dusting operation.

In a case where the task content is “cleaning by picking up something on a floor” and the first control method is a control method for “limiting measurement values only to a task target area near a floor,” the information to be reduced is determined as a “distance to an object located at a height equal to or higher than a certain height.” In a case where the task content is “cleaning by picking up items on the floor” and the information to be reduced is a “distance to object located at a height equal to or higher than a certain height,” the second control method is determined as “slowing an operation speed of a task execution apparatus.” By limiting the measurement values only to the task target area near the floor, the information amount on the distance to the object located at a height equal to or higher than the certain height decreases, so the control method of the task execution apparatus is determined to clean more safely without interfering with the object located at a height equal to or higher than the certain height.

In a case where the task content is “wiping a floor” and the first control method is a control method of “providing a position and orientation of a task execution apparatus and a grayscale image,” the information to be reduced is determined as a “position and orientation of an object with a similar color to that of the floor.” In a case where the task content is “wiping a floor” and the information to be reduced is a “position and orientation of an object with a similar color to that of the floor,” the second control method is determined as “slowing down the operation speed of the task execution apparatus.” By providing the grayscale image, an information amount on the position and orientation of the object with a similar color to that of the floor and the distance to the object is reduced. Thereby, the control method of the task execution apparatus is determined so as to avoid interference with the object with a similar color to that of the floor during the cleaning task and to clean more safely.

In a case where the task content is “suction cleaning without caring about materials” and the first control method is a control method of “providing a grayscale image,” the information to be reduced is determined as a “position and orientation of an object with a similar color to that of the floor.” In a case where the task content is “suction cleaning without caring about materials” and the information to be reduced is a “position and orientation of an object with a similar color to that of the floor,” the second control method is determined as “slowing the operation speed of the task execution apparatus.” By providing a grayscale image, the information amount of the position and orientation of the object with a similar color to that of the floor and distance to the object is reduced. Thereby, the control method of the task execution apparatus is determined so as to avoid interference with the object with a similar color to that of the floor during the cleaning task and to clean more safely.

In a case where the task content is “packing task” and the first control method is a control method of “providing shape and color information only within a task area,” the information to be reduced is determined to be a “position and orientation of an object outside a task area.” In a case where the task content is “packing task” and the information to be reduced is a “position and orientation of an object outside a task area,” the second control method is determined as “slowing an operation speed of a task execution apparatus.” By providing shape and color information only within the task area, the information amount of position and orientation of the objects outside the task area is reduced. Thereby, the control method of the task execution apparatus is determined so as to avoid interference with an object with a similar color to that of the floor during the packing task and to more safely operate.

Even in a case where the task cannot be performed by processing the information alone, this example can achieve both confidentiality maintenance and task execution by adjusting the operation of the task execution apparatus.

### Example 3

A description will be given of Example 3 according to the present disclosure. This example will discuss a method for achieving both confidentiality maintenance and task execution without processing the information provided to the task execution apparatus 103.

This example determines and executes a method for controlling the task execution apparatus 103 so that the task execution apparatus 103 removes surrounding objects that are subject to confidentiality from its sensing range (so that objects that are subject to confidentiality are located outside the sensing range of the sensor) while securing the task execution. Thereby, both confidentiality maintenance and task execution can be achieved, even in a case where the problem cannot be solved by processing any information. A method for determining a specific control method will be described later.

The application scene of the information processing apparatus 202 according to this example is similar to that illustrated in FIG. 1, and thus a description thereof will be omitted. The configuration of the vision system 200 according to this example is similar to that illustrated in FIG. 2, and thus a description thereof will be omitted.

Referring now to FIG. 4, a description will be given of the processing (information processing method) of the information processing apparatus 202 according to this example. FIG. 4 is a flowchart illustrating the processing executed by the information processing apparatus 202 according to this example, and a description common to Example 1 and Example 2 will be omitted.

In step S404 in FIG. 4, the following contents are determined. In a case where the task content is “serving food,” the details of the task are other than those mentioned above, and the confidential information is a “shape and color of a surrounding specific object,” a control method is determined as “changing a route of the task execution apparatus to one that does not sense a specific object.” The route determined here is a moving route of the task execution apparatus 103 such that the specific object that is subject to confidentiality is not included in the sensing field angle of the task execution apparatus 103. At this time, assume that the task execution apparatus 103 is equipped with an omni-wheel mechanism. Thereby, in a case where the moving route is directly controlled, the task execution apparatus 103 can execute the task while traveling on the route that does not measure the specific object that is subject to confidentiality, and therefore the above control method is determined.

Even in a case where information processing is prohibited, this example can achieve both confidentiality maintenance and the task execution to only an area that is subject to confidentiality.

### Variation 3

A description will now be given of Variation 3 of this example. The above example determines the control method of “changing the route of the task execution apparatus to one that does not sense the specific object,” but may determine another control method as long as the task execution apparatus has a pan/tilt mechanism of the sensor. For example, in a case where the task content is “serving food,” the details of the task are “the task execution apparatus is equipped with a pan/tilt mechanism,” and the confidential information is a “shape and color of the surrounding specific object,” the control method of the task execution apparatus 103 may be determined as “changing a pan/tilt value to one that does not sense the specific object.” More specifically, a horizontal prospective angle of the specific object and prospective angles at both ends excluding the horizontal prospective angle are calculated from the area size of the specific object that is subject to confidentiality in a captured image acquired from the sensor-information acquiring unit 206. Then, the sum of the horizontal prospective angle of the specific object and the smaller one of the prospective angles other than it is determined as the pan/tilt angle at which the specific object does not fall within the sensing range.

Thereby, in the case of the task execution apparatus equipped with the pan/tilt mechanism, by applying the pan/tilt angle to the task execution apparatus 103, the task can be performed without measuring the specific target that is subject to confidentiality.

### Example 4

A description will now be given of Example 4 of the present disclosure. This example will discuss a method of notifying a visual-system management user of the control content that protects confidential information according to the task content when the task execution apparatus 103 and the visual system cooperate with each other using Examples 1 to 3. In this example, the application scene of the information processing apparatus 202 is similar to that in FIG. 1, and a description thereof will be omitted.

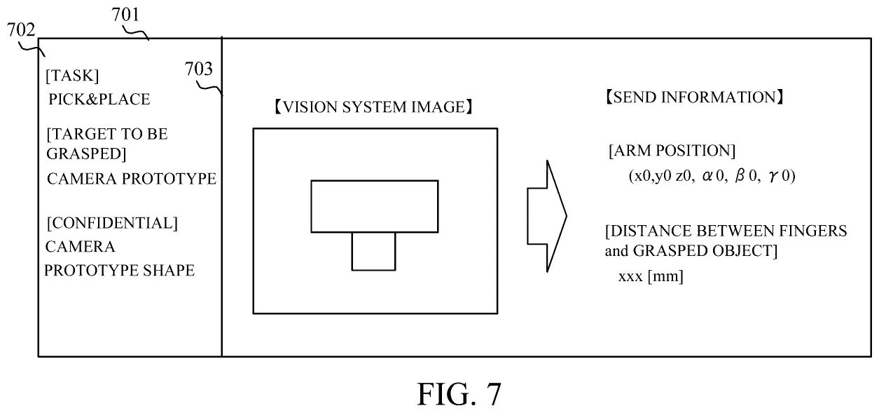

Referring now to FIGS. 2 and 7, a description will be given of the configuration of the vision system 200 according to this example. The information processing apparatus 202 according to this example includes a display unit (notifying unit) in addition to the configuration in FIG. 2. The other configurations are similar to those of the other examples, and a detailed description thereof will be omitted. The display unit notifies the results of at least one of the sensor-information acquiring unit 206, the task-information acquiring unit 205, the control method determining unit 207, the control unit 208, and the confidential specific information acquiring unit.

FIG. 7 illustrates a display screen 701 of the display unit (notifying unit) according to this example, and is an example of a display screen in the usage form of Example 1. The display screen 701 illustrates the result of determining the control method of “providing a position and orientation of a finger hand and a distance between fingers and an object” when the task content is “pick-and-place,” the task details are a “target (to be grasped) (or grasping target) has a simple shape,” and the confidential information is the “shape of the grasping target.”

The display screen 701 includes a unique information display unit 702. The unique information display unit 702 displays the task content, the task target, and the confidential information. The display screen 701 includes a control-content display unit 703. The control-content display unit 703 displays the sensor information measured by the vision system 102 on the left side, and displays at least one of the contents, which is determined by the control method determining unit 207, of processing the information to be provided to the task execution apparatus 103, the contents of changing the sensing range of the task execution apparatus 103, or the control contents to be performed by the control unit 208, on the right side.

This example can notify the visual-system management user of the contents that reconcile the confidentiality maintenance and task execution.

### Variation 4

A description will now be given of Variation 4. The above example uses a GUI format to notify the control content that protects confidential information according to the task content, but is not limited to this implementation, and may use another format as long as the control content that protects confidential information according to the task content can be notified to the visual-system management user. For example, a format in which the contents are notified in text format is also acceptable.

Thereby, the control content that protects confidential information can be notified according to the task content described in the fourth example, regardless of the hardware of the display unit that supports the GUI display or CUI display.

### Variation 5

A description will now be given of Variation 5 of this example. In the above example, the notification contents are the display contents of the unique information display unit 702 and the control-content display unit 703. This example is not limited to this implementation, and may notify other information additionally as long as it is information on the determination of the control content. For example, an intermediate product that is used to determine the control content or the correspondence table of FIG. 5 or FIG. 6 may be additionally displayed. Thereby, various information on confidentiality maintenance and task execution can be notified.

In each example, confidential information is information that the user does not desire to leak to the outside. The confidential information can be previously determined by the user. The user can also change the confidential information depending on the situation, such as the task content. The confidential information can be previously stored in memory, but can also be properly set when used.

In each example, the control method determining unit 207 determines the control method for executing the task based on the confidential information included in the measurement information or recognition information, and the task information (the task content), but is not limited to this implementation. Even if a part of information (specific information) included in the measurement information or recognition information is not likely to be confidential information strictly speaking, the user may minimize the information transmitted to the task execution apparatus 103. Thus, regardless of whether or not a part of the information (specific information) included in the measurement information or the recognition information is confidential information specified by the user, at least a part of the information included in the measurement information or the recognition information may be processed in accordance with the task information.

That is, the information processing apparatus 202 may be configured to transmit only information necessary for task execution to the task execution apparatus 103 in accordance with the task information (i.e., for each content or type of work). The information necessary for the task execution may be previously set in accordance with the task content, or may be determined by the user in accordance with the task content. The information necessary for the task execution may be information that is essential for the task execution, but is not limited to this implementation as long as the information does not include at least a part of the information included in the measurement information or the recognition information that is unnecessary for the task execution.

That is, regardless of whether or not specific information included in the measurement information or the recognition information is confidential information specified by the user, the specific information may be processed (corrected) in accordance with the task content. Here, processing of the specific information means performing processing such as deleting, correcting, or blurring (reducing the resolution of) the specific information. However, the processing is not limited, and may be, for example, deforming the shape of an object included in the measurement information or the recognition information, or changing the color of the object.

Thereby, even if a part of information (specific information) included in the measurement information or recognition information may not be strictly confidential information, the information to be sent to the task execution apparatus 103 can be processed according to the task content, and the transmission of information unnecessary for the task. Even in this form can substantially reconcile confidentiality maintenance and task execution.

Each example can provide an information processing apparatus, information processing method, and a storage medium, each of which can achieve both confidentiality maintenance and task execution.

### OTHER EMBODIMENTS

Embodiment(s) of the disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions.

The computer-executable instructions may be provided to the computer, for example, from a network or the storage medium. The storage medium may include, for example, one or more of a hard disk, a random-access memory (RAM), a read-only memory (ROM), a storage of distributed computing systems, an optical disc (such as a compact disc (CD), digital versatile disc (DVD), or Blu-ray Disc (BD)™), a flash memory device, a memory card, and the like.

While the disclosure has described example embodiments, it is to be understood that the disclosure is not limited to the example embodiments. The scope of the following claims is to be accorded the broadest interpretation so as to encompass all such modifications and equivalent structures and functions.

Each example can provide an information processing apparatus that can achieve confidentiality maintenance and task execution.

This application claims priority to Japanese Patent Application No. 2024-087184, which was filed on May 29, 2024, and which is hereby incorporated by reference herein in its entirety.

What is claimed is:

1. An information processing apparatus comprising:
at least one processor that executes instructions to:
acquire measurement information obtained by measuring a target of a task and a periphery of target, or recognition information recognized based on the measurement information,
acquire a content of the task as task information,
determine a control method for executing the task based on confidential information contained in the measurement information or the recognition information, and the task information, and
execute the control method based on the measurement information or the recognition information.

2. The information processing apparatus according to claim 1, wherein the processor is configured to:
determine a processing method for processing the measurement information or the recognition information,
wherein the processing method is at least one of reducing a resolution, reducing a dimension, limiting a spatial range, or replacing with abstract information.

3. The information processing apparatus according to claim 2, wherein the processor is configured to determine an operation of a task execution apparatus configured to execute the task according to the processing method.

4. The information processing apparatus according to claim 3, wherein the processor is configured to determine the operation of the task execution apparatus so as not to measure the confidential information.

5. The information processing apparatus according to claim 4, wherein the processor is configured to determine the operation of the task execution apparatus so that the confidential information is outside a sensing range of a sensor.

6. The information processing apparatus according to claim 1, further comprising a notifying unit configured to notify a result by the processor.

7. An information processing apparatus comprising:
at least one processor that executes instructions to:
acquire measurement information obtained by measuring a target of a task and a periphery of target, or recognition information recognized based on the measurement information,
acquire a content of the task as task information,
determine a processing method for processing the measurement information or the recognition information based on the task information, and
control a task execution apparatus based on the measurement information or the recognition information processed by the processing method.

8. An information processing method executed by a computer mounted on an information processing apparatus comprising:
acquiring measurement information obtained by measuring a target of a task and a periphery of target, or recognition information recognized based on the measurement information,
acquiring a content of the task as task information,
determining a control method for executing the task based on confidential information contained in the measurement information or the recognition information, and the task information, and
executing the control method based on the measurement information or the recognition information.

9. A non-transitory computer-readable storage medium storing a program that causes a computer to execute the information processing method according to claim 8.

10. An information processing method executed by a computer mounted on an information processing apparatus, the information processing method comprising:
acquiring measurement information obtained by measuring a target of a task and a periphery of target, or recognition information recognized based on the measurement information,
acquiring a content of the task as task information,
determining a processing method for processing the measurement information or the recognition information based on the task information, and controlling a task execution apparatus based on the measurement information or the recognition information processed by the processing method.

11. A non-transitory computer-readable storage medium storing a program that causes a computer to execute the information processing method described in claim 10.
